(19) United States
(12) Patent Application Publication
(10) Pub. No.: US 2026/0064800 A1
(43) Pub. Date: Mar. 5, 2026

(54) RECORDING MEDIUM, INFORMATION PROCESSING METHOD, AND INFORMATION PROCESSING DEVICE

(71) Applicant: Fujitsu Limited, Kawasaki-shi (JP)

(72) Inventor: Yu LIU, Kawasaki (JP)

(73) Assignee: Fujitsu Limited, Kawasaki-shi (JP)

(21) Appl. No.: 19/381,035

(22) Filed: Nov. 6, 2025

Related U.S. Application Data
(63) Continuation of application No. PCT/JP2023/021881, filed on Jun. 13, 2023.

(51) Int. Cl. G06F 17/11; G06N 10/20; G06N 10/60

(52) U.S. Cl. CPC G06F 17/11; G06N 10/20; G06N 10/60

(57) ABSTRACT

A computer-readable recording medium stores therein an information processing program for causing a computer to execute a process, the process including: calculating a first solution of a combinatorial optimization problem based on an Ising model corresponding to the combinatorial optimization problem; determining a value of a parameter of a quantum approximation optimization algorithm corresponding to the combinatorial optimization problem so as to maximize a probability that a quantum state of a quantum circuit of the quantum approximation optimization algorithm becomes the calculated first solution; and calculating a second solution of the combinatorial optimization problem based on the quantum circuit of the quantum approximation optimization algorithm in which the determined value of the parameter is set.

### CROSS REFERENCE TO RELATED APPLICATIONS

This application is a continuation application of International Application PCT/JP2023/021881, filed on Jun. 13, 2023, and designating the U.S., the entire contents of which are incorporated herein by reference.

### FIELD

The embodiments discussed herein are related to a recording medium, an information processing method, and an information processing device.

### BACKGROUND

Conventionally, there is a quantum approximation optimization algorithm that solves a combinatorial optimization problem. For example, a combinatorial optimization problem is solved by repeating a series of processes of identifying a quantum state of a quantum circuit, identifying energy corresponding to the identified quantum state, and changing a parameter of the quantum circuit based on the identified energy.

According to one prior art, for example, an artificial intelligence (AI) controller determines one or more adjustable parameters corresponding to a calculation. Further, for example, the technique includes a technique of mapping a cost function associated with a combinatorial optimization problem to an optimization problem over allowed quantum states. In addition, for example, in a general aspect, there is a technique of selecting a value of a parameter of a quantum approximation optimization algorithm by a Bayesian optimizer. In addition, for example, there is a technique of executing a quantum approximation optimization algorithm. For example, refer to Published Japanese-Translation of PCT Application, Publication No. 2022-509841, Published Japanese-Translation of PCT Application, Publication No. 2021-504805, U.S. Pat. No. 10,846,366, and U.S. Patent Application Publication No. 2022/0245497.

### SUMMARY

According to an aspect of an embodiment, a computer-readable recording medium stores therein an information processing program for causing a computer to execute a process, the process including: calculating a first solution of a combinatorial optimization problem based on an Ising model corresponding to the combinatorial optimization problem; determining a value of a parameter of a quantum approximation optimization algorithm corresponding to the combinatorial optimization problem so as to maximize a probability that a quantum state of a quantum circuit of the quantum approximation optimization algorithm becomes the calculated first solution; and calculating a second solution of the combinatorial optimization problem based on the quantum circuit of the quantum approximation optimization algorithm in which the determined value of the parameter is set.

An object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is an explanatory diagram depicting an example of an information processing method according to an embodiment.

FIG. 2 is an explanatory diagram depicting an example of an information processing system 200.

FIG. 3 is a block diagram of an example of a hardware configuration of an information processing device 100.

FIG. 4 is a block diagram depicting an example of a functional configuration of the information processing device 100.

FIG. 5 is an explanatory diagram depicting an example of operation of the information processing device 100.

FIG. 6 is an explanatory diagram depicting an example of the operation of the information processing device 100.

FIG. 7 is an explanatory diagram depicting an example of the operation of the information processing device 100.

FIG. 8A is an explanatory diagram depicting an example of the operation of the information processing device 100.

FIG. 8B is an explanatory diagram depicting an example of the operation of the information processing device 100.

FIG. 8C is an explanatory diagram depicting an example of the operation of the information processing device 100.

FIG. 9 is a flowchart depicting an example of an overall processing procedure.

FIG. 10 is a flowchart depicting an example of a procedure of a first determination process.

FIG. 11 is a flowchart depicting an example of a procedure of a second determination process.

### DESCRIPTION OF EMBODIMENTS

First, problems associated with the conventional techniques are discussed. With the related arts, it is difficult to efficiently solve a combinatorial optimization problem. For example, the time necessary to solve the combinatorial optimization problem tends to increase.

Embodiments of a computer-readable recording medium, an information processing method, and an information processing device according to the present disclosure is described in detail with reference to the accompanying drawings.

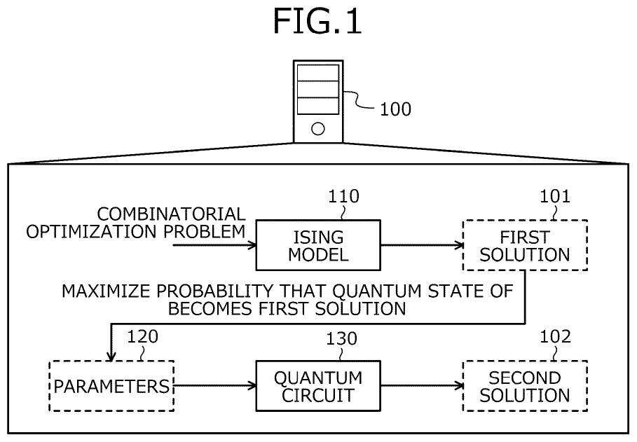

FIG. 1 is an explanatory diagram depicting an example of an information processing method according to an embodiment. The information processing device 100 is a computer for solving a combinatorial optimization problem. The information processing device 100 is, for example, a server or a personal computer (PC).

Here, the combinatorial optimization problem is a problem that seeks, as a solution, a combination of variables so as to optimize a value of an objective function under constraint conditions. Conventionally, as a method of solving a combinatorial optimization problem, for example, there is a simulated annealing (SA) method, a quantum approximation optimization algorithm, and the like. In the following description, the quantum approximate optimization algorithm may be referred to as “QAOA”.

The SA method is, for example, a method of solving a combinatorial optimization problem by repeatedly searching for combinations of variables while adjusting the range for searching for the combinations of variables using thermal noise. The QAOA is, for example, a method of solving a combinatorial optimization problem using a quantum circuit representing a quantum state corresponding to a combination of variables. The SA method is also called, for example, simulated annealing.

More specifically, the QAOA solves a combinatorial optimization problem by repeating a series of processes including “identifying a quantum state of a quantum circuit, identifying energy corresponding to the identified quantum state, and changing a parameter of the quantum circuit based on the identified energy”. More specifically, the QAOA uses a grid method, a BFGS method, a quadratic approximation method, a Powell method, Bayesian estimation, or the like when changing the parameters of the quantum circuit.

For the QAOA, for example, Farhi, Edward, Jeffrey Goldstone, and Sam Gutmann. “A quantum approximate optimization algorithm.” arXiv preprint arXiv: 1411.4028 (2014) may be referred to. For the Grid method, for example, Streif, Michael, and Martin Leib. “Forbidden subspaces for level-1 quantum approximate optimization algorithm and instantaneous quantum polynomial circuits.” Physical Review A 102.4 (2020): 042416 may be referred to. For the BFGS method, for example, Streif, Michael, and Martin Leib. “Training the quantum approximate optimization algorithm without access to a quantum processing unit.” Quantum Science and Technology 5.3 (2020): 034008 may be referred to. For the quadratic approximation method, for example, Shaydulin, Ruslan, and Yuri Alexeev. “Evaluating quantum approximate optimization algorithm: A case study.” 2019 tenth international green and sustainable computing conference (IGSC). IEEE, 2019 may be referred to. For the Bayesian estimation, for example, Tibaldi, Simone, et al. “Bayesian Optimization for QAOA.” arXiv preprint arXiv: 2209.03824 (2022) may be referred to.

However, with the related art, it is difficult to efficiently solve a combinatorial optimization problem. For example, the time necessary to solve the combinatorial optimization problem tends to increase. More specifically, in the SA method, the farther the initial value is from the optimal solution, the longer the time necessary to solve the combinatorial optimization problem and find the optimal solution tends to be. The quantum annealing method has a similar tendency. Regarding this tendency, for example, Katzgraber, Helmut G., et al. “Seeking quantum speedup through spin glasses: The good, the bad, and the ugly.” Physical Review X 5.3 (2015): 031026 may be referred to.

More specifically, in the QAOA, the energy and the parameters of the quantum circuit may have a non-convex relationship, and the time necessary to appropriately change the parameters tends to increase. Thus, there is a problem in that it is difficult to find optimum parameters.

Thus, in the present embodiment, an information processing method capable of easily solving a combinatorial optimization problem is described.

In FIG. 1, an information processing device 100 obtains a combinatorial optimization problem. The information processing device 100 obtains, for example, an objective function min (E=C(z)) of the combinatorial optimization problem. For example, z is a state and represents a combination of variables. E is, for example, energy. Here, it is desired to obtain a state z that minimizes E=C(z) which is a solution of the combinatorial optimization problem. For example, the information processing device 100 sets a quantum circuit 130 of the QAOA corresponding to the combinatorial optimization problem representing the quantum state corresponding to the state z. The quantum state probabilistically represents, for example, each possible value of the state z.

(1-1) The information processing device 100 calculates a first solution 101 of the combinatorial optimization problem based on an Ising model 110 corresponding to the obtained combinatorial optimization problem. For example, the information processing device 100 calculates a state z₀ that is the first solution 101 of the combinatorial optimization problem based on the Ising model 110 of a digital annealer and the set initial value using the Ising machine of the digital annealer. The initial value is set in advance by the user, for example. The initial value is, for example, the value of the state z.
(1-2) The information processing device 100 determines the values of the parameters 120 of the quantum circuit 130 such that the probability that the set quantum state of the quantum circuit 130 becomes the calculated first solution 101 is maximized. The information processing device 100 calculates a second solution 102 of the combinatorial optimization problem based on the quantum circuit 130 in which the determined values of the parameters 120 are set.

The information processing device 100 performs nshot sampling for the quantum state using, for example, a quantum processing unit (QPU) and calculates a state z₁ that is the second solution 102. More specifically, the information processing device 100 repeatedly performs a Z-direction projection measurement on the quantum state represented by the quantum circuit 130 in which the determined value of the parameter 120 is set to obtain the state z n times, and calculates the state z₁ serving as the second solution 102 based on the distribution of the obtained states z.

Accordingly, the information processing device 100 may easily solve the combinatorial optimization problem. The information processing device 100 may appropriately set the parameters 120 of the quantum circuit 130 based on the first solution 101 calculated using the Ising model 110, and may reduce the time necessary to perform QAOA. The information processing device 100 may obtain the state z₁ that is relatively close to the optimal solution and is a preferable solution.
(1-3) The information processing device 100 may set the calculated state z₁ as a new initial value and repeatedly perform the series of processes described in (1-1) and (1-2) until a convergence condition is satisfied. The convergence condition is, for example, that the series of processes is performed a predetermined number of times. Accordingly, the information processing device 100 may accurately solve the combinatorial optimization problem. The information processing device 100 may obtain the state z₁ that is closer to the optimal solution and is a preferable solution.

Here, while a case where the information processing device 100 is a single computer has been described, the present disclosure is not limited hereto. For example, functions of the information processing device 100 may be implemented by multiple computers. More specifically, functions of the information processing device 100 may be implemented on a cloud.

Here, while a case where the information processing device 100 includes an Ising machine has been described, the present disclosure is not limited hereto. For example, the information processing device 100 may control another computer including an Ising machine to calculate the first solution 101 of the combinatorial optimization problem and obtain the first solution 101.

Here, while a case where the information processing device 100 includes the QPU has been described, the present disclosure is not limited hereto. For example, the information processing device 100 may obtain the second solution 102 by controlling another computer including the QPU to calculate the second solution 102 of the combinatorial optimization problem.

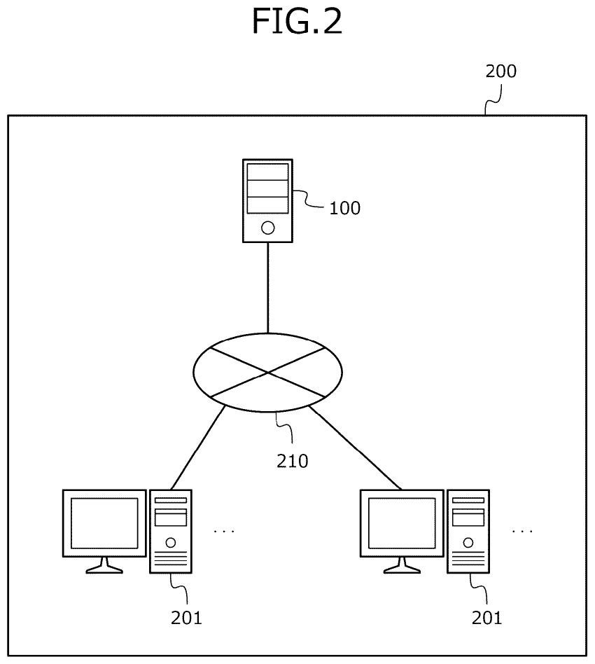

Next, an example of an information processing system 200 to which the information processing device 100 depicted in FIG. 1 is applied is described with reference to FIG. 2.

FIG. 2 is an explanatory diagram depicting an example of the information processing system 200. In FIG. 2, the information processing system 200 includes the information processing device 100 and a client apparatus 201.

In the information processing system 200, the information processing device 100 and the client apparatus 201 are coupled via a wired or wireless network 210. The network 210 is, for example, a local area network (LAN), a wide area network (WAN), the Internet, or the like.

The information processing device 100 is a computer for solving a combinatorial optimization problem. (2-1) The information processing device 100 receives, for example, information indicating a combinatorial optimization problem from the client apparatus 201. For example, the information processing device 100 identifies a combinatorial optimization problem, based on the received information. For example, the information processing device 100 identifies a quantum circuit of QAOA corresponding to the identified combinatorial optimization problem. For example, the information processing device 100 sets an initial value of an Ising model corresponding to a combinatorial optimization problem.
(2-2) The information processing device 100 calculates the first solution of the combinatorial optimization problem, for example, based on the set initial value and the Ising model corresponding to the combinatorial optimization problem. For example, the information processing device 100 determines the values of the parameters of the identified quantum circuit so that the probability that the quantum state of the identified quantum circuit becomes the calculated first solution is maximized. For example, the information processing device 100 calculates the second solution of the combinatorial optimization problem based on the quantum circuit in which the determined parameter values are set.
(2-3) For example, the information processing device 100 sets the calculated second solution as a new initial value of the Ising model, and repeatedly performs the series of processes described in (2-2) until the convergence condition is satisfied. The convergence condition is, for example, that the series of processes is performed a predetermined number of times. When the convergence condition is satisfied, the information processing device 100 sets the second solution calculated last as the solution of the combinatorial optimization problem. The information processing device 100 transmits the solution of the combinatorial optimization problem to the client apparatus 201. The information processing device 100 is, for example, a server or a PC.

The client device 201 is a computer used by a worker who requests the solving of a combinatorial optimization problem. For example, the client device 201 generates information indicating a combinatorial optimization problem based on an operational input by an operator and transmits the information to the information processing device 100. The information indicating the combinatorial optimization problem includes, for example, an objective function of the combinatorial optimization problem. The information indicating the combinatorial optimization problem may include, for example, a constraint condition of the combinatorial optimization problem. The client apparatus 201 receives the solution of the combinatorial optimization problem from the information processing device 100. The client device 201 outputs the solution of the combinatorial optimization problem so that the operator may refer to the solution. The client device 201 is, for example, a PC, a tablet terminal, or a smartphone.

Here, while a case where the information processing device 100 is a computer different from the client apparatus 201 has been described, the present disclosure is not limited hereto. For example, the information processing device 100 may function as the client apparatus 201 and may also operate as the client apparatus 201.

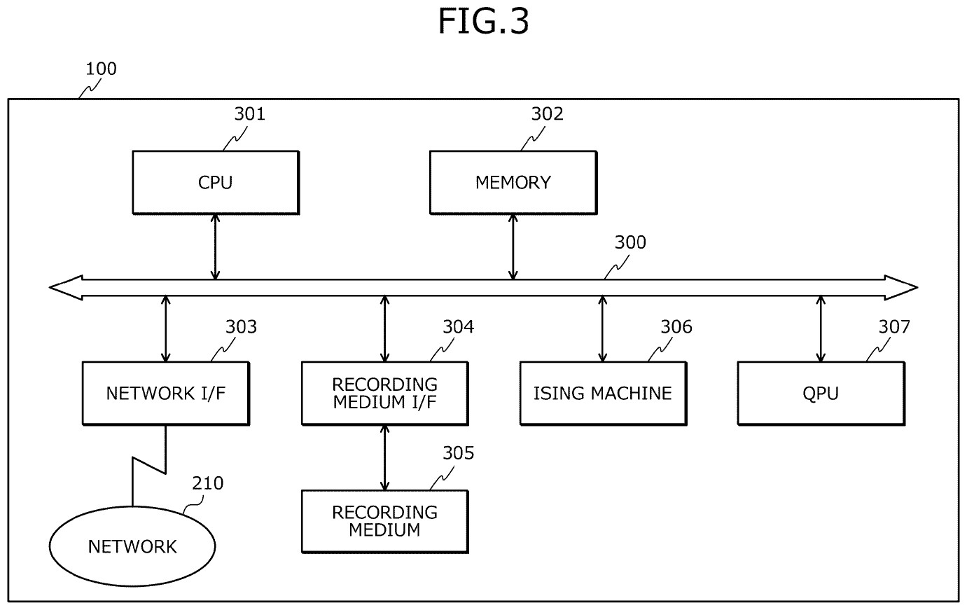

Next, an example of a hardware configuration of the information processing device 100 is described with reference to FIG. 3.

FIG. 3 is a block diagram of an example of a hardware configuration of the information processing device 100. In FIG. 3, the information processing device 100 has a central processing unit (CPU) 301, a memory 302, a network interface (I/F) 303, a recording medium I/F 304, and a recording medium 305. The information processing device 100 further has an Ising machine 306 and a QPU 307. Further, the components are connected to each other by a bus 300.

Here, the CPU 301 governs overall control of the information processing device 100. The memory 302, for example, includes a read-only memory (ROM), a random access memory (RAM), and a flash-ROM. In particular, for example, the flash-ROM and/or ROM stores therein various programs and the RAM is used as a work area of the CPU 301. Programs stored to the memory 302 are loaded onto the CPU 301, whereby encoded processes are executed by the CPU 301.

The network I/F 303 is coupled to the network 210 via a communications line and is coupled to other computers through the network 210. Further, the network I/F 303 administers an internal interface with the network 210 and controls the input and output of data with respect to the other computers. The network I/F 303, for example, is a modem, a LAN adapter, or the like.

The recording medium I/F 304 controls the reading and writing of data with respect to the recording medium 305 under the control of the CPU 301. The recording medium I/F 304 is, for example, a disk drive, a solid-state drive (SSD), a universal serial bus (USB) port, or the like. The recording medium 305 is a nonvolatile memory storing data written thereto under the control of the recording medium I/F 304. The recording medium 305 is, for example, a disk, a semiconductor memory, a USB memory, or the like. The recording medium 305 may be removable from the information processing device 100.

The Ising machine 306 is a computing device that has an Ising model and solves a combinatorial optimization problem by executing a digital annealer using the Ising model. The QPU 307 is a computing device that executes a quantum operation defined in a quantum circuit. The QPU 307 solves the combinatorial optimization problem, for example, by executing the QAOA.

The information processing device 100 may include, for example, a keyboard, a mouse, a display, a printer, a scanner, a microphone, a speaker, and/or the like in addition to the above-described components. The information processing device 100 may include the recording medium I/F 304 in plural and the recording medium 305 in plural. The information processing device 100 may omit the recording medium I/F 304 and the recording medium 305.

An example of a hardware configuration of the client apparatus 201 is similar to the example of the hardware configuration of the information processing device 100 depicted in FIG. 3 and thus, description thereof is omitted.

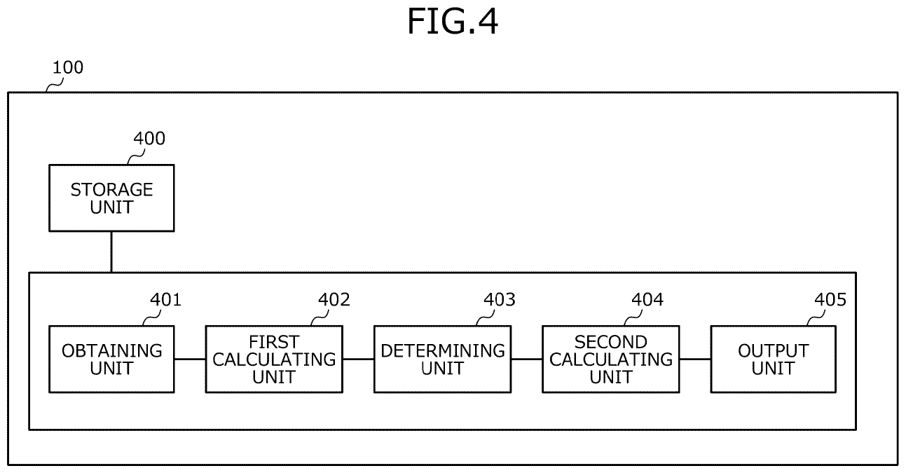

Next, an example of a functional configuration of the information processing device 100 is described with reference to FIG. 4.

FIG. 4 is a block diagram depicting an example of a functional configuration of the information processing device 100. The information processing device 100 includes a storage unit 400, an obtaining unit 401, a first calculating unit 402, a determining unit 403, a second calculating unit 404, and an output unit 405.

The storage unit 400 is realized by, for example, a storage area such as the memory 302 or the recording medium 305 depicted in FIG. 3. Hereinafter, while a case where the storage unit 400 is included in the information processing device 100 is described, the present disclosure is not limited hereto. For example, the storage unit 400 may be included in a device different from the information processing device 100, and the stored contents of the storage unit 400 may be referred to by the information processing device 100.

The obtaining unit 401 to the output unit 405 function as an example of a controller. More specifically, the functions of the obtaining unit 401 to the output unit 405 are realized, for example, by causing the CPU 301 to execute a program stored in a storage area such as the memory 302 or the recording medium 305 depicted in FIG. 3 or by the network I/F 303. The processing results of each functional unit are stored to, for example, a storage area such as the memory 302 or the recording medium 305 depicted in FIG. 3.

The storage unit 400 stores various types of information referred to or updated in the processes of the functional units. The storage unit 400 stores, for example, information indicating a combinatorial optimization problem. Information indicating the combinatorial optimization problem includes, for example, an objective function of the combinatorial optimization problem. The information indicating the combinatorial optimization problem may include, for example, a constraint condition of the combinatorial optimization problem. The information indicating the combinatorial optimization problem is obtained by, for example, the obtaining unit 401. The information indicating the combinatorial optimization problem may be set by the user in advance, for example.

The storage unit 400 stores, for example, an Ising model corresponding to a combinatorial optimization problem. The Ising model is obtained by, for example, the obtaining unit 401. The Ising model may be set by the user in advance, for example. The storage unit 400 stores, for example, an initial value of the Ising model. The initial value corresponds to a candidate solution of the combinatorial optimization problem. The initial value is obtained by the obtaining unit 401, for example. The initial value may be set in advance by the user, for example.

The storage unit 400 stores, for example, a quantum circuit of the QAOA corresponding to the combinatorial optimization problem. The quantum circuit of the QAOA represents a procedure of quantum operations. The quantum circuit of the QAOA has a function of outputting a quantum state corresponding to a solution of the combinatorial optimization problem. The quantum circuit of the QAOA is obtained by, for example, the obtaining unit 401. The quantum circuit of the QAOA may be set by a user in advance, for example.

The obtaining unit 401 obtains various types of information used for the processes of the functional units. The obtaining unit 401 stores the obtained various types of information to the storage unit 400 or outputs the obtained various types of information to the functional units. In addition, the obtaining unit 401 may output various types of information stored in the storage unit 400 to the functional units. The obtaining unit 401 obtains various types of information based on, for example, an operational input of a user. For example, the obtaining unit 401 may receive various types of information from a device different from the information processing device 100.

The obtaining unit 401 obtains, for example, a processing request requesting to solve a combinatorial optimization problem. The processing request may include information indicating a combinatorial optimization problem, an Ising model, an initial value of the Ising model, and a quantum circuit of the QAOA. More specifically, the obtaining unit 401 obtains the quantum circuit of the QAOA by receiving an input of the quantum circuit of the QAOA based on an operational input of a user. More specifically, the obtaining unit 401 may receive a quantum circuit of the QAOA from another computer. The other computer is, for example, the client apparatus 201.

The obtaining unit 401 obtains, for example, information indicating a combinatorial optimization problem. More specifically, the obtaining unit 401 obtains the information indicating the combinatorial optimization problem by receiving an input of the information indicating the combinatorial optimization problem based on an operational input of the user. More specifically, the obtaining unit 401 may receive information indicating a combinatorial optimization problem, from another computer. The other computer is, for example, the client apparatus 201. More specifically, the obtaining unit 401 may obtain the information indicating the combinatorial optimization problem by extracting the information from the processing request.

The obtaining unit 401 obtains, for example, the Ising model. More specifically, the obtaining unit 401 obtains the Ising model by receiving an input of the Ising model based on an operational input of a user. More specifically, the obtaining unit 401 may receive the Ising model from another computer. The other computer is, for example, the client apparatus 201. More specifically, the obtaining unit 401 may obtain the Ising model by extracting the Ising model from the processing request.

The obtaining unit 401 obtains, for example, an initial value of the Ising model. More specifically, the obtaining unit 401 obtains the initial value of the Ising model by receiving the input of the initial value of the Ising model based on the operational input of the user. More specifically, the obtaining unit 401 may receive the initial value of the Ising model from another computer. The other computer is, for example, the client apparatus 201. More specifically, the obtaining unit 401 may obtain the initial value of the Ising model by extracting the initial value from the processing request.

The obtaining unit 401 obtains, for example, a quantum circuit of QAOA. More specifically, the obtaining unit 401 obtains the quantum circuit of the QAOA by receiving an input of the quantum circuit of the QAOA based on an operational input of a user. More specifically, the obtaining unit 401 may receive the quantum circuit of the QAOA from another computer. The other computer is, for example, the client apparatus 201. More specifically, the obtaining unit 401 may obtain the QAOA quantum circuit by extracting the QAOA quantum circuit from the processing request.

The obtaining unit 401 may receive a start trigger for starting the process of any of functional units. The start trigger is, for example, a predetermined operational input by the user. The start trigger may be, for example, reception of predetermined information from another computer. The start trigger may be, for example, output of predetermined information by any of functional units. For example, the obtaining unit 401 regards obtaining the processing request as a start trigger for starting the processes of the first calculating unit 402, the determining unit 403, and the second calculating unit 404.

The first calculating unit 402 calculates a first solution of the combinatorial optimization problem based on the Ising model. For example, in response to obtaining the processing request by the obtaining unit 401, the first calculating unit 402 calculates the first solution of the combinatorial optimization problem based on the set initial value and the Ising model. Thus, the first calculating unit 402 may obtain a guideline for determining the parameters of the QAOA and may easily determine the parameters of the QAOA.

For example, each time the second calculating unit 404 calculates the second solution, the first calculating unit 402 sets the second solution as an initial value. For example, each time the second calculating unit 404 calculates the second solution, the first calculating unit 402 newly calculates the first solution of the combinatorial optimization problem based on the set initial value and the Ising model. Thus, the first calculating unit 402 may obtain a guideline for determining the parameters of the QAOA, and may easily determine the parameters of the QAOA. The first calculating unit 402 corresponds to, for example, the Ising machine 306.

The determining unit 403 determines the values of the parameters of the QAOA such that the probability that the quantum state of the quantum circuit of the QAOA becomes the first solution calculated by the first calculating unit 402 is maximized. For example, each time the first calculating unit 402 calculates the first solution, the determining unit 403 determines the values of the parameters of the QAOA such that the probability that the quantum state of the quantum circuit of the QAOA becomes the first solution is maximized. Accordingly, the determining unit 403 may appropriately determine the parameters of the QAOA and may easily calculate the second solution of the combinatorial optimization problem, based on the quantum circuit of the QAOA.

The second calculating unit 404 calculates a second solution of the combinatorial optimization problem based on the QAOA quantum circuit in which the parameter values determined by the determining unit 403 are set. For example, each time the determining unit 403 determines the value of a parameter, the second calculating unit 404 sets the value of the parameter in the quantum circuit of the QAOA. The second calculating unit 404 calculates the second solution of the combinatorial optimization problem based on, for example, a quantum circuit of the QAOA in which the parameter values are set. Accordingly, the second calculating unit 404 may calculate an appropriate solution of the combinatorial optimization problem. The second calculating unit 404 corresponds to the QPU 307.

The information processing device 100 repeatedly executes a series of processes of the first calculating unit 402, the determining unit 403, and the second calculating unit 404 until a predetermined condition is satisfied. The predetermined condition is, for example, perform the series of processes a predetermined number of times. Accordingly, the information processing device 100 may bring the second solution calculated by the second calculating unit 404 close to the optimal solution of the combinatorial optimization problem.

The output unit 405 outputs a processing result of at least one of the functional units. The output format is, for example, display on a display, print output to a printer, transmission to an external device by the network I/F 303, or storage in a storage area such as the memory 302 or the recording medium 305. Accordingly, the output unit 405 may notify the user of the processing result of at least one of the functional units, and the convenience of the information processing device 100 may be improved.

The output unit 405 outputs the second solution calculated by the second calculating unit 404. The output unit 405 outputs, for example, the second solution calculated last by the second calculating unit 404. More specifically, the output unit 405 outputs the second solution calculated last by the second calculating unit 404 so that the user may refer to the second solution. More specifically, the output unit 405 may transmit the second solution calculated last by the second calculating unit 404 to another computer. Accordingly, the output unit 405 may make the solution of the combinatorial optimization problem available to the outside.

Here, while case where the information processing device 100 includes the first calculating unit 402 and the second calculating unit 404 has been described, the present disclosure is not limited hereto. For example, the information processing device 100 may use the first calculating unit 402 by communicating with another computer including the first calculating unit 402. For example, the information processing device 100 may use the second calculating unit 404 by communicating with another computer having the second calculating unit 404.

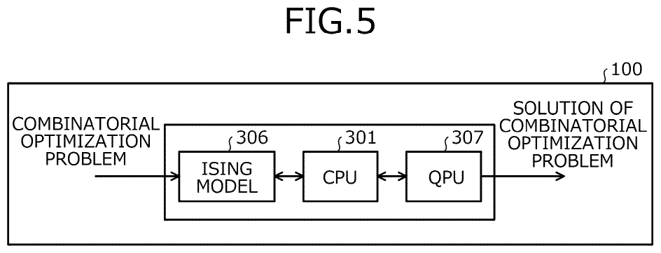

Next, an example of operation of the information processing device 100 is described with reference to FIGS. 5 to 8C.

FIGS. 5, 6, 7, 8A, 8B, and 8C are explanatory diagrams depicting an example of the operation of the information processing device 100. In FIG. 5, the information processing device 100 obtains information indicating the combinatorial optimization problem min(E=C(z)). E is energy. E=C(z) is an objective function to be minimized. z is the state. The information processing device 100 identifies the combinatorial optimization problem min (E=C(z)) based on the information indicating the combinatorial optimization problem.

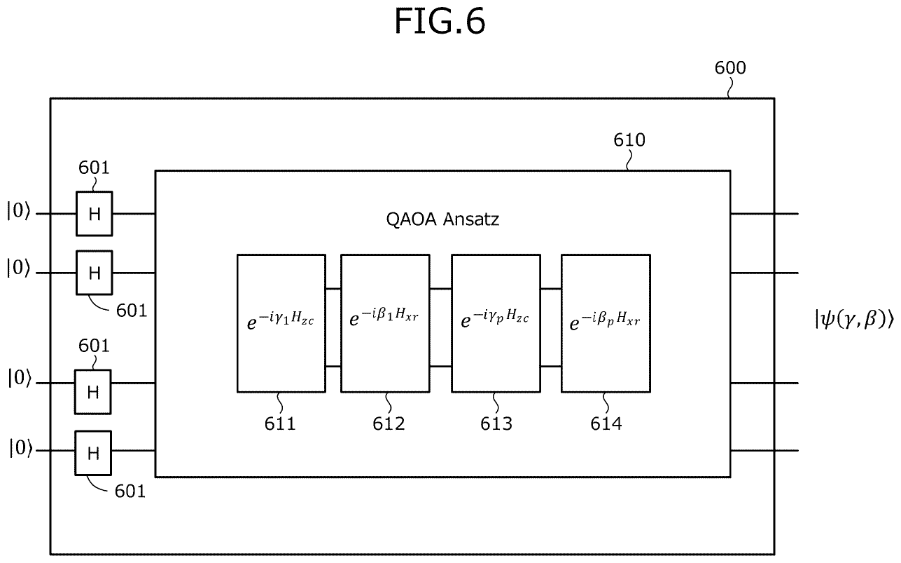

The information processing device 100 has an initial value for the Ising model. The initial value is, for example, the value of the state z. The information processing device 100 sets a quantum circuit 600 of the QAOA corresponding to the combinatorial optimization problem. An example of the quantum circuit 600 of the QAOA will be described with reference to FIG. 6.

FIG. 6 depicts an example of a QAOA quantum circuit 600. In FIG. 6, a quantum circuit 600 of the QAOA includes a Hadamard gate 601 representing an operation over states respectively of n qubits and a QAOA Ansatz 610 representing an operation over the states of the n qubits. n is the number of qubits.

QAOA Ansatz 610 represents gates 611-614. The gates 611 and 613 represent, for example, phase separation operators. The gates 612 and 614 represent, for example, mixing operators. The QAOA Ansatz 610 is defined by hyperparameters (γ, β). In the example depicted in FIG. 6, the level of QAOA Ansatz 610 is 2.

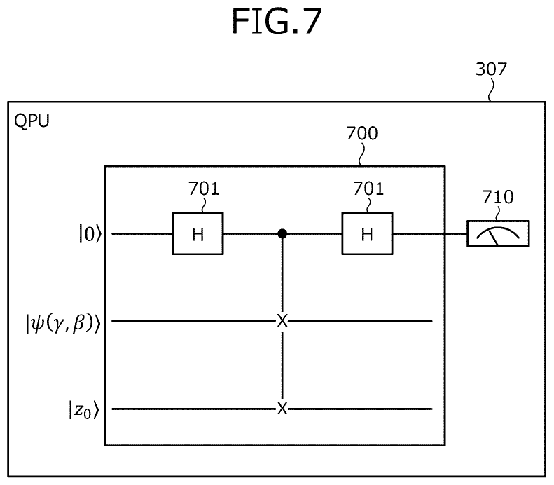

Here, description with reference to FIG. 5 continues. (5-1) The information processing device 100 calculates the state z₀ that is a solution C(z), based on the Ising model and the initial value, by the Ising machine 306. The information processing device 100 calculates the state z₀ that is the solution C(z), based on the Ising model and the initial value, by the Ising machine 306 according to the digital annealer, for example.
(5-2) The information processing device 100 determines, by the CPU 301 and the QPU 307, hyperparameters (γ*, β*) so as to maximize the probability that the quantum state |Ψ(γ, β)> of the quantum circuit 600 of the QAOA becomes z₀. Here, an example in which the information processing device 100 determines the hyperparameters (γ*, β*) is described with reference to FIG. 7.

FIG. 7 depicts an example of determining hyperparameters (γ*, β*). In FIG. 7, (7-1) the information processing device 100 applies a superposition state |s> to n qubits by the QPU 307. The superimposed state |s> is defined by, for example, the following equation (1).

$${\vert s 〉 = \vert + 〉}^{⊗ n} \qquad ( 1 )$$

The information processing device 100 identifies the quantum state |Ψ(γ, β)> by multiplying the n qubits by U_{c}(γ₁)Uₓ(β₁) . . . U_{c}(γₚ)Uₓ(βₚ) according to p (γᵢ, βᵢ) by the QPU 307. Here, i=1, 2, . . . , p.

The information processing device 100 measures the probability p_{z0}(γ, β)=<Ψ(γ, β)|z₀> <z₀|Ψ(γ, β)>=<Ψ(γ, β)|z₀>² by performing a swap test by the QPU 307. The information processing device 100 measures the probability p_{z0}(γ, β)=<Ψ(γ, β)|z₀> <z₀|Ψ(γ, β)> according to, for example, the quantum circuit 700 of the swap test depicted in FIG. 7. The quantum circuit 700 of the swap test includes a Hadamard gate 701 and allows p_{z0}(γ, β)=<Ψ(γ, β)|z₀> <z₀|Ψ(γ, β)> to be measured at a measurement point 710.

More specifically, the information processing device 100 measures the probability p_{z0}(γ, β) based on the result of nshot sampling of the quantum state of the measurement point 710 according to the quantum circuit 700 of the swap test depicted in FIG. 7. More specifically, in the information processing device 100, if n=1000, the probability p_{z0}(γ, β)=10/1000 when the number of times the quantum state of the measurement location 710 is measured as 0 is 10.

The information processing device 100 causes the CPU 301 to determine the hyperparameters (γ*, β*) such that the measured probability p_{z0}(γ, β) is maximized. The information processing device 100 sets an objective function that maximizes the probability p_{z0}(γ, β) using, for example, a Grid method, a BFGS method, a quadratic approximation method, a Powell method, Bayesian estimation, or the like, and calculates the hyperparameters (γ*, β*).

The information processing device 100 causes the CPU 301 to repeatedly determine the hyperparameters (γ*, β*) as described above. When the CPU 301 calculates the hyperparameters (γ*, β*) a predetermined number of times, the information processing device 100 statistically determines the hyperparameters (γ*, β*). The predetermined number of times is set in advance, for example. The predetermined number of times is, for example, a first number.

Here, description with reference to FIG. 5 continues. (5-3) the information processing device 100 performs nshot sampling of the quantum state |Ψ(γ*, β*)> based on (γ*, β*) according to the quantum circuit 600 of QAOA by the CPU 301 and the QPU 307, and determines the optimal classical state z₁*. Here, an example of determining the optimal classical state z₁* will be described with reference to FIG. 6 again.

FIG. 6 depicts an example of determining the optimal classical state z₁*. In FIG. 6, the information processing device 100 applies the superposition state |s> to n qubits by the QPU 307. The information processing device 100 identifies the quantum state |Ψ(γ*, β*)> by multiplying the n qubits by U_{c}(γ₁)Uₓ(β₁) . . . U_{c}(γₚ)Uₓ(βₚ) according to (γ*, β*) by the QPU 307. The information processing device 100 performs nshot sampling of the quantum state |Ψ(γ*, β*)> by the QPU 307 to determine n classical states z₁. For example, the information processing device 100 causes the QPU 307 to repeatedly perform the Z-direction projection measurement with respect to the quantum state |Ψ(γ*, β*)> represented by the quantum circuit 600 of the QAOA in which (γ*, β*) is set to obtain the state z n times, and determines n classical states z₁.

The information processing device 100 determines, by the CPU 301, a classical state z₁* to be a provisional solution of the combinatorial optimization problem based on n classical states z₁. The information processing device 100 determines, for example, by the CPU 301, whether min(E₁)<min(E₀, E_{1*}) is satisfied. Here, for example, when min(E₁)<min(E₀, E_{1*}), the information processing device 100 determines z₁* as argmin(E₁) by the CPU 301. On the other hand, for example, when min(E₁)<min(E₀, E_{1*}) is not satisfied, the information processing device 100 determines z₁* based on E₁ and the Hamming Distance, by the CPU 301.

Here, description with reference to FIG. 5 continues. (5-4) The information processing device 100 determines, by the CPU 301, whether an end condition is satisfied. The end condition is, for example, that a series of the processes (5-1) to (5-3) is performed a predetermined number of times. The predetermined number of times is set in advance, for example. The predetermined number of times is, for example, a second number. The second number may be the same as the first number. The termination condition may be defined by, for example, a threshold value for the energy E or the state z.

When the end condition is not satisfied, the information processing device 100 sets the optimal classical state z₁* determined this time as the initial value of the Ising machine 306, by the CPU 301, and performs the series of processes of (5-1) to (5-3) again.

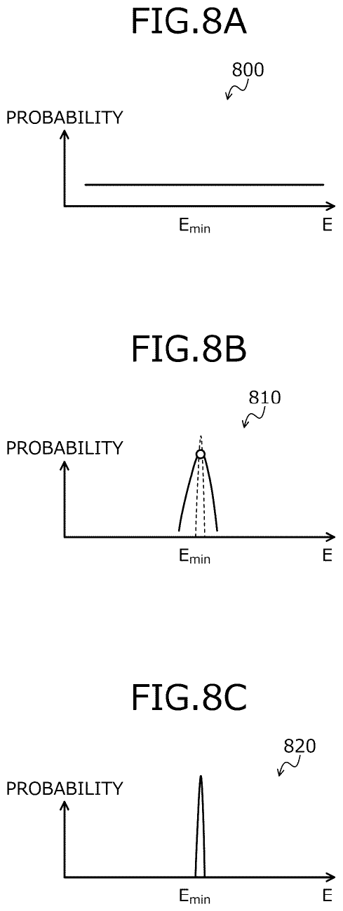

When the end condition is satisfied, the information processing device 100 outputs min(C(z₀), C(z₁*)) and argmin(C(z)). argmin(C(z)) is, for example, z₀ or z₁*. Accordingly, the information processing device 100 may accurately calculate argmin(C(z)) that is a solution of the combinatorial optimization problem. The information processing device 100 may reduce the time necessary to calculate a solution to the combinatorial optimization problem. Next, with reference to FIGS. 8A, 8B, and 8C, effects of the information processing device 100 are described.

FIGS. 8A, 8B, and 8C depict an effect of the information processing device 100. A graph 800 in FIG. 8A initially represents a distribution of probabilities that quantum states represent classical states z taking respective values of energy E. As depicted in the graph 800 of FIG. 8A, initially, the distribution of probabilities that the quantum states represent the classical states z taking respective values of energy E is uniform.

On the other hand, for the combinatorial optimization problem, the information processing device 100 determines hyperparameters (γ, β) according to the calculation result of the Ising machine 306 prior to the QAOA such that the probability that the quantum state represents the classical state z having a value around Emin is high. A graph 810 in FIG. 8B depicts a distribution of probabilities that a quantum state represents a classical state z taking respective values of the energy E after determining the hyperparameters (γ, β). As depicted in the graph 810 of FIG. 8B, the probability that the quantum state represents the classical state z having a value around Emin increases. Accordingly, the information processing device 100 may improve the efficiency of searching for an optimal solution by the QAOA.

Then, after increasing the probability that the quantum state represents the classical state z having a value around Emin, the information processing device 100 calculates the solution of the combinatorial optimization problem by the QAOA. A graph 820 in FIG. 8C represents a distribution of probabilities that a quantum state represents a classical state z having each of the values of the energy E when a solution of a combinatorial optimization problem is calculated by the QAOA. As depicted in the graph 820 in FIG. 8C, the probability that the quantum state represents the classical state z having a value in a narrow range closer to Emin around Emin is high.

Accordingly, the information processing device 100 may efficiently and accurately approximate the solution of the combinatorial optimization problem to an optimal solution by the QAOA. For example, the information processing device 100 may consider all states represented by a quantum state that may be a solution to a combinatorial optimization problem by the QAOA, and may accurately calculate a solution to the combinatorial optimization problem. Therefore, the information processing device 100 may reduce the time necessary to calculate a solution of the combinatorial optimization problem by the QAOA.

Here, while a case where the information processing device 100 determines the hyperparameters (γ*, β*) and determines the optimal classical state z₁* using the QPU 307 has been described, the present disclosure is not limited hereto. For example, the information processing device 100 may include a simulator of a quantum computer. More specifically, the information processing device 100 determines the hyperparameters (γ*, β*) using a simulator of a quantum computer, and determines the optimal classical state z₁*.

Next, an application example of the information processing device 100 is described. The information processing device 100 may be applied to, for example, a case of solving a combinatorial optimization problem for searching for a movement route of a mobile object. For example, the information processing device 100 may be applied to a case of solving a combinatorial optimization problem for creating a work table of employees. For example, the information processing device 100 may be applied to a case of solving a combinatorial optimization problem for creating a manufacturing plan of a product.

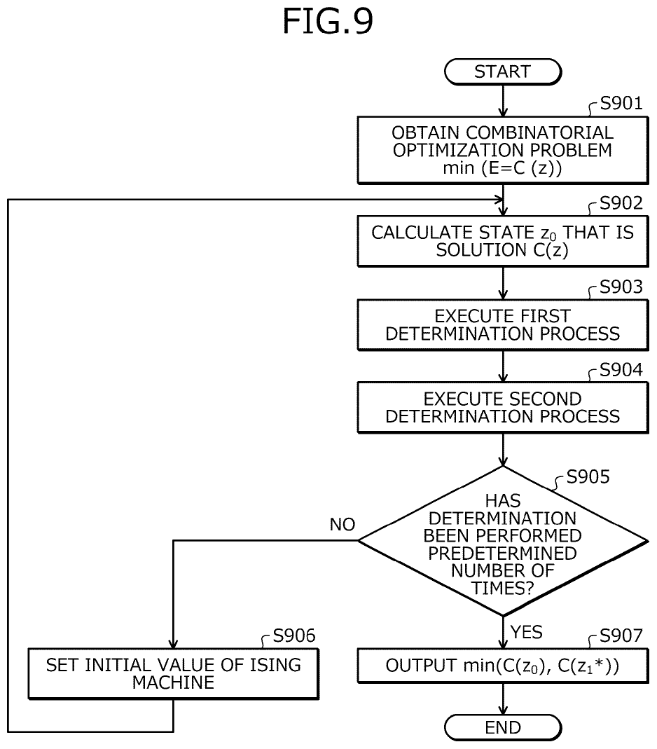

Next, an example of an overall processing procedure executed by the information processing device 100 is described with reference to FIG. 9. The overall processing is implemented by, for example, the CPU 301, the storage area such as the memory 302 or the recording medium 305, the network I/F 303, the Ising machine 306, and the QPU 307 depicted in FIG. 3.

FIG. 9 is a flowchart depicting an example of the overall processing procedure. In FIG. 9, the information processing device 100 obtains a combinatorial optimization problem min(E=C(z)) by the CPU 301 (step S901). Next, the information processing device 100 calculates a state z₀ that is a solution C(z) based on the initial value, by the Ising machine 306 (step S902).

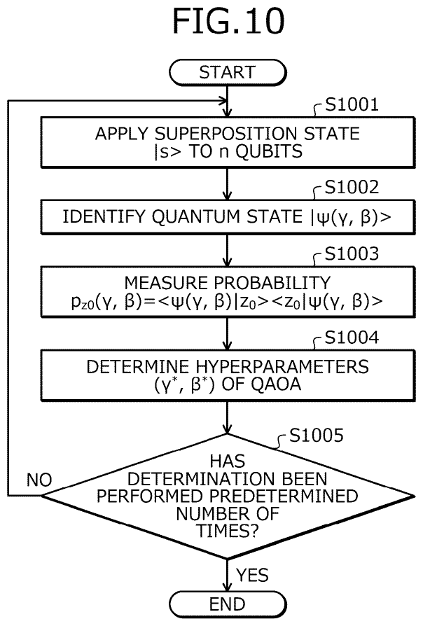

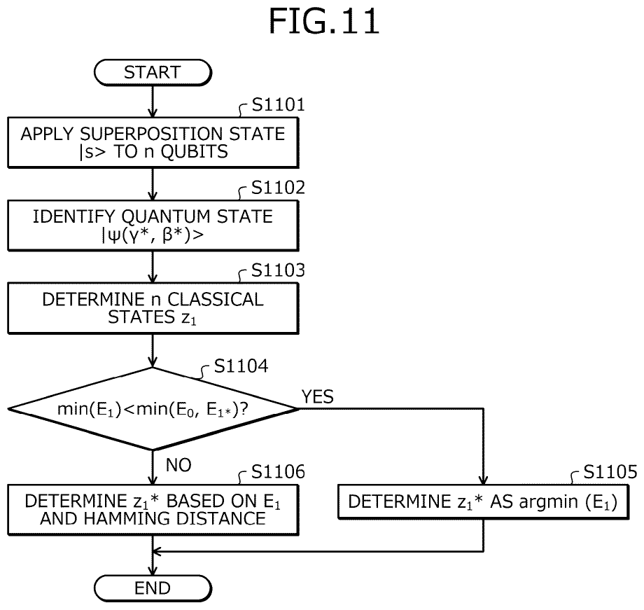

Next, the information processing device 100 causes the QPU 307 to execute a first determination process described later with reference to FIG. 10, thereby determining the hyperparameters (γ*, β*) of the QAOA so that the probability that the quantum state |Ψ(γ, β)> becomes z₀ is maximized (step S903). Then, the information processing device 100 performs nshot sampling of the quantum state |Ψ(γ*, β*)> and determines the optimal classical state z₁* by executing second determination process described later with reference to FIG. 11 by the QPU 307 (step S904).

Next, the information processing device 100 determines whether the optimal classical state z₁′ has been determined a predetermined number of times (step S905). The predetermined number of times is set in advance by the user, for example. Here, in a case where the determination has not been performed the predetermined number of times (step S905: NO), the information processing device 100 proceeds to the process at step S906. On the other hand, when the predetermined number of times has been determined (step S905: YES), the information processing device 100 proceeds to the process at step S907.

At step S906, the information processing device 100 sets the initial value of the Ising machine 306 to the optimal classical state z₁′ (step S906). Then, the information processing device 100 returns to the process at step S902.

At step S907, the information processing device 100 outputs min(C(z₀), C(z₁*)) (step S907). The information processing device 100 may output argmin(C(z)). Then, the information processing device 100 ends the entire process.

Next, an example of a procedure of the first determination process executed by the information processing device 100 is described with reference to FIG. 10. The first determination process is implemented by, for example, the CPU 301, the storage area such as the memory 302 or the recording medium 305, the network I/F 303, and the QPU 307 depicted in FIG. 3.

FIG. 10 is a flowchart depicting an example of a procedure of the first determination process. In FIG. 10, the information processing device 100 applies the superposition state |s> to n qubits (step S1001). Next, the information processing device 100 identifies a quantum state |Ψ(γ, β)> by multiplying the n qubits by U_{c}(γ₁)Uₓ(β₁) . . . U_{c}(γₚ)Uₓ(βₚ) for p (γi, βi) (step S1002).

Next, the information processing device 100 measures the probability p_{z0}(γ, β)=<Ψ(γ, β)|z₀> <z₀|Ψ(γ, β)> (step S1003). Then, the information processing device 100 determines the hyperparameters (γ*, β*) of the QAOA so that the probability p_{z0}(γ, β) is maximized (step S1004).

Next, the information processing device 100 determines whether the hyperparameters (γ*, β*) of the QAOA have been determined a predetermined number of times (step S1005). The predetermined number of times is set in advance by the user, for example. Here, when the hyperparameters (γ*, β*) of the QAOA have not been determined the predetermined number of times (step S1005: NO), the information processing device 100 returns to the process at step S1001. On the other hand, when the determination has been performed the predetermined number of times (step S1005: YES), the information processing device 100 ends the first determination process.

Next, an example of a procedure of the second determination process executed by the information processing device 100 is described with reference to FIG. 11. The second determination process is implemented by, for example, the CPU 301, the storage area such as the memory 302 or the recording medium 305, the network I/F 303, and the QPU 307 depicted in FIG. 3.

FIG. 11 is a flowchart depicting an example of a procedure of the second determination process. In FIG. 11, the information processing device 100 applies the superposition state |s> to n qubits (step S1101).

Next, the information processing device 100 identifies a quantum state |Ψ(γ*, β*)> by multiplying the n qubits by U_{c}(γ₁)Uₓ(β₁) . . . U_{c} (γₚ) Uₓ βₚ) according to the latest (γ*, β*) (step S1102). Then, the information processing device 100 performs nshot sampling on the quantum state |Ψ(γ*, β*)> to determine n classical states z₁ (step S1103).

Next, the information processing device 100 calculates energy E₁ corresponding to each classical state z₁ and determines whether min(E₁)<min(E₀, E_{1*}) is satisfied (step S1104). E₀ is the energy corresponding to z₀. E_{1*} is the energy corresponding to z₁*. z₁* represents a classical state determined to be optimal at the present time.

Here, when min(E₁)<min(E₀, E_{1*}) is satisfied (step S1104: YES), the information processing device 100 proceeds to the process at step S1105. On the other hand, when min(E₁)<min(E₀, E_{1*}) is not satisfied (step S1104: NO), the information processing device 100 proceeds to the process at step S1106.

At step S1105, the information processing device 100 determines z₁* as argmin(E₁) (step S1105). argmin(E₁) represents a classical state z₁ that takes min(E₁) among E₁ corresponding to each classical state z₁. Then, the information processing device 100 ends the second determination process.

At step S1106, the information processing device 100 determines z₁* based on E₁ and Hamming Distance (step S1106). E₁, Hamming Distance is, for example, ((E₁−E₀)×Hamming Distance (z₁, z₀))⁻¹. Then, the information processing device 100 ends the second determination process. Here, the information processing device 100 may omit the process at some steps of the flowcharts of FIGS. 9 to 11. For example, the processes at steps S905 and S906 may be omitted. For example, the process at step S1005 may be omitted.

As described above, according to the information processing device 100, it is possible to calculate the first solution of the combinatorial optimization problem based on the Ising model corresponding to the combinatorial optimization problem. According to the information processing device 100, it is possible to determine the values of the parameters of the quantum approximation optimization algorithm so that the probability that the quantum state of the quantum circuit of the quantum approximation optimization algorithm corresponding to the combinatorial optimization problem becomes the calculated first solution is maximized. According to the information processing device 100, the second solution of the combinatorial optimization problem may be calculated based on the quantum circuit of the quantum approximation optimization algorithm in which the determined parameter values are set. Accordingly, the information processing device 100 may reduce the time necessary to accurately calculate the solution to the combinatorial optimization problem.

According to the information processing device 100, a series of processes including calculating the first solution, determining the value of the parameter, and calculating the second solution may be repeatedly executed until a predetermined condition is satisfied. Accordingly, the information processing device 100 may improve the accuracy of calculating the solution of the combinatorial optimization problem.

According to the information processing device 100, the calculation of the second solution a predetermined number of times may be adopted as the predetermined condition. Accordingly, the information processing device 100 may repeatedly execute a series of processes an appropriate number of times and may accurately calculate a solution to a combinatorial optimization problem.

According to the information processing device 100, it is possible to output the calculated second solution. Accordingly, the information processing device 100 may make the second solution available externally as a solution of the combinatorial optimization problem.

According to the information processing device 100, it is possible to calculate the first solution of the combinatorial optimization problem based on the Ising model by using the Ising machine that solves the combinatorial optimization problem. According to the information processing device 100, it is possible to calculate the second solution of the combinatorial optimization problem based on the quantum circuit of the quantum approximation optimization algorithm in which the determined parameter values are set by using the quantum computing device that handles the quantum circuit of the quantum approximation optimization algorithm. Accordingly, the information processing device 100 may efficiently calculate the first solution and may efficiently calculate the second solution.

According to the information processing device 100, it is possible to calculate the first solution of the combinatorial optimization problem based on the Ising model according to the digital annealer. Accordingly, the information processing device 100 may efficiently calculate the first solution.

The information processing method described in the present embodiment may be implemented by executing a prepared program on a computer such as a personal computer and a workstation. The program is stored on a non-transitory, computer-readable recording medium such as a hard disk, a flexible disk, a compact disc read-only memory (CD-ROM), a magneto-optical (MO) disc, and a digital versatile disc (DVD), read out from the computer-readable medium, and executed by the computer. The program may be distributed through a network such as the Internet.

According to the embodiment, it is possible to easily solve a combinatorial optimization problem.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a depicting of the superiority and inferiority of the invention. Although one or more embodiments of the present disclosure have been described in detail, it should be understood that the various changes, substitutions, and alterations could be made hereto without departing from the spirit and scope of the invention.

What is claimed is:

1. A computer-readable recording medium storing therein an information processing program for causing a computer to execute a process, the process comprising:
calculating a first solution of a combinatorial optimization problem based on an Ising model corresponding to the combinatorial optimization problem;
determining a value of a parameter of a quantum approximation optimization algorithm corresponding to the combinatorial optimization problem so as to maximize a probability that a quantum state of a quantum circuit of the quantum approximation optimization algorithm becomes the calculated first solution; and
calculating a second solution of the combinatorial optimization problem based on the quantum circuit of the quantum approximation optimization algorithm in which the determined value of the parameter is set.

2. The computer-readable recording medium according to claim 1, the process further comprising:
newly calculating the first solution of the combinatorial optimization problem based on the Ising model in which the calculated second solution is set as an initial value; and
newly determining the value of the parameter so as to maximize a probability that the quantum state of the quantum circuit of the quantum approximation optimization algorithm becomes the newly calculated first solution; and
newly calculating the second solution of the combinatorial optimization problem based on the quantum circuit of the quantum approximation optimization algorithm in which the newly determined value of the parameter is set, wherein
the newly calculating the first solution, the newly determining the value of the parameter, and the newly calculating the second solution are repeatedly performed until a predetermined condition is satisfied.
The computer-readable recording medium according to claim 2, wherein the predetermined condition is that the second solution is calculated a predetermined number of times.

4. The computer-readable recording medium according to claim 1, the process further comprising outputting the calculated second solution.
The computer-readable recording medium according to claim 1, wherein
the calculating the first solution includes calculating the first solution of the combinatorial optimization problem by using an Ising machine that solves the combinatorial optimization problem, and
the calculating the second solution includes calculating the second solution of the combinatorial optimization problem by using a quantum computing device that processes the quantum circuit of the quantum approximation optimization algorithm.

6. An information processing method executed by a computer, the method comprising:
calculating a first solution of a combinatorial optimization problem based on an Ising model corresponding to the combinatorial optimization problem;
determining a value of a parameter of a quantum approximation optimization algorithm corresponding to the combinatorial optimization problem so as to maximize a probability that a quantum state of a quantum circuit of the quantum approximation optimization algorithm becomes the calculated first solution; and
calculating a second solution of the combinatorial optimization problem based on the quantum circuit of the quantum approximation optimization algorithm in which the determined value of the parameter is set.
An information processing device comprising:
a memory; and
a processor coupled to the memory, the process configured to:
calculate a first solution of a combinatorial optimization problem based on an Ising model corresponding to the combinatorial optimization problem;
determine a value of a parameter of a quantum approximation optimization algorithm corresponding to the combinatorial optimization problem so as to maximize a probability that a quantum state of a quantum circuit of the quantum approximation optimization algorithm becomes the calculated first solution; and
calculate a second solution of the combinatorial optimization problem based on the quantum circuit of the quantum approximation optimization algorithm in which the determined value of the parameter is set.
